(19) United States
(12) Patent Application Publication
(10) Pub. No.: US 2015/0365479 A1
(43) Pub. Date: Dec. 17, 2015

(54) ELECTRONIC VEHICLE INFORMATION SYSTEM, ELECTRONIC LICENSE PLATES AND OTHER RELATED DEVICES AND METHODS

(71) Applicant: Thomas W. Cunningham, Orlando, FL (US)

(72) Inventor: Thomas W. Cunningham, Orlando, FL (US)

(21) Appl. No.: 14/833,705

(22) Filed: Aug. 24, 2015

Related U.S. Application Data
(62) Division of application No. 14/041,439, filed on Sep. 30, 2013, now abandoned.
(60) Provisional application No. 61/708,199, filed on Oct. 1, 2012.

(51) Int. Cl. H04L 29/08; G07C 5/00; B60Q 1/50; B60R 13/10

(52) U.S. Cl. CPC H04L 67/12; B60R 13/105; G07C 5/008; B60Q 1/503

(57) ABSTRACT

Vehicles are equipped with communications devices and electronic controllers that store vehicle-related information and communicate the information with a plurality of extra-vehicular data sources, including traffic signal systems and remote data storage. The vehicle can be equipped with display devices that can be driven by the electronic controller to function as electronic license plates. The electronic license plates or other display devices are altered to indicate changes in vehicle status. Communicated information is used by a plurality of additional systems, for purposes including code enforcement, vehicle status monitoring, vehicle localization, and theft and fraud prevention.

### CROSS-REFERENCE TO RELATED APPLICATION

This application is a divisional of U.S. patent application Ser. No. 14/041,439, which claims of the benefit of U.S. Provisional Patent Application Ser. No. 61/708,199, filed on Oct. 1, 2012, the contents of which are herein incorporated by reference in their entirety.

### FIELD OF THE INVENTION

The present invention relates to systems and methods for sending, receiving and displaying vehicle information, and more particularly, to vehicle registration and licensing information.

### BACKGROUND OF THE INVENTION

Although electronic devices have revolutionized many areas of life for individuals, business and governments alike, there are many areas past which technological advances seem to have marched, unnoticed. For example, vehicle registration is still evidenced by a stamped or printed license plate, with registration renewals often being indicated by a sticker.

By noting license plate numbers visually, or with newer automated license plate recognition systems, government officials and other authorized/interested parties can obtain much relevant vehicle information, provided access to the relevant database(s). While this has proved of great use over the years, there are still deficiencies.

For example, the physical plates are liable to theft—which would handicap the ability to properly identify a vehicle and the data that would otherwise be associated therewith. The renewal stickers are liable to be stolen or fall off, provided the vehicle owner remembered to affix them in the first place. Additionally, where license plate detection and comparison is not automatic, determining which if any license plates are of interest is left to the discretion of personnel. A license plate for a stolen or overweight vehicle, or one that just ran two stop signs, looks the same as any other license plate.

### SUMMARY OF THE INVENTION

In view of the foregoing, it is an object of the present invention to provide an improved vehicle information system, electronic license plates and other related systems, devices and methods.

According to an embodiment of the present invention, an electronic vehicle license plate system comprises at least one display device for mounting externally on a vehicle, at least one communications device for sending and receiving data to and from at least one extra-vehicular data source, and at least one electronic controller for vehicular mounting, the at least one electronic controller in signal communication with the at least one display device and the at least one communications device and configured to operate the at least one display device to display a unique vehicle identifier.

According to aspects of the present invention, the unique identifier includes alphanumeric characters, and the at least display device is mounted on a license plate mounting area of the vehicle. The system can comprise additional display devices, mounted internally or exteriorly—both in conventional license plate locations and at other locations.

According to a further aspect of the present invention, the at least one communications device includes a data port for sending and receiving data to and from the at least one extra-vehicular data source, and a transmitter and receiver for wirelessly sending and receiving data to and from the at least one extra-vehicular data source.

According to additional aspects of the present invention, the at least one communications device is configured to send and receive vehicle status information, which can include at least one of: vehicle speed; vehicle weight; vehicle registration status; vehicle insurance status; vehicle traffic signal compliance; vehicle maintenance status; vehicle owner/driver information; and vehicle crime involvement. The vehicle owner/driver information can include one or more of: vehicle driver age; vehicle driver license status; and vehicle driver authorization. The electronic controller can advantageously alter the display device(s) based on the vehicle status information, and/or execute a vehicle control. Possible vehicle controls include: vehicle speed limitation; and vehicle operation disablement.

According to another aspect, the vehicle owner/driver information includes vehicle driver authorization and the at least one communications device is configured to receive a vehicle driver authorization signal from a driver authorization mechanism, the at least one electronic controller determining the vehicle driver authorization based upon receipt of the vehicle driver authorization signal.

In further aspects, the electronic controller is configured to energize the at least one display device in response to the data received from the extra-vehicular data source and/or send and receive vehicle identifying information from the at least one extra-vehicular data source. Vehicle identifying information includes at least one of: vehicle identification number; vehicle component serial numbers; vehicle make/model; vehicle year; vehicle color; and vehicle pictures (from a plurality of angles—e.g., side, top, front, rear). Where the vehicle identifying information includes vehicle component serial numbers, the electronic controller is preferably configured to permit updating the vehicle component serial numbers only with special authorization.

According to yet another aspect, the at least one communications device is configured to send and receive data from a traffic light system and the at least one electronic controller is configured to alter the at least one display device in response to date from the traffic light system.

According to another embodiment of the present invention, a vehicle information collection and dissemination system comprises at least one communications device for sending and receiving vehicular data to and from communications devices in vehicles and other extra-vehicular data sources; and at least one processor with machine-readable memory configured to communicate with the communications devices in vehicles and other extra-vehicular data sources.

According to an aspect of the present invention, the at least one processor and memory are configured to send instructions to the at least one vehicle to energize a display device thereof to display vehicle information.

According to a further aspect, the at least one processor and memory are configured to communicate at least one vehicle location to another extra-vehicular data source, the communicated at least one vehicle location being based upon a vehicle with which the at least communications device communicated and a known location of the system. The at least one processor and memory can also be configured to receive at least one vehicle location from another extra-vehicular data source.

According to an additional embodiment, a computer-based method of vehicle theft and fraud prevention comprises determining a plurality of component identifiers for vehicle components for a vehicle from a list of component identifiers stored electronically in the vehicle; and comparing the stored component identifiers with the actual component identifiers.

According to a method aspect, the stored component identifiers from the at least one vehicle are compared with a list of component identifiers stored in an extra-vehicular data source. A component identifier for a replacement component can be updated, which preferably includes an authorization step. Preferably, automatic alert notifications are generated where discrepancies are found.

For a vehicle manufacturer, the method can include initially assigning component identifiers for all tracked components in a newly-manufactured vehicle. Vehicle resale, repair or replacement entities will check component identifiers, as appropriate, and vehicle junk/scrap yards will check component identifiers and indicate scrapped status.

These and other objects, aspects and advantages of the present invention will be better appreciated in view of the drawings and following detailed description of preferred embodiments.

### BRIEF DESCRIPTION OF THE DRAWINGS

FIG. 1 is a schematic overview of a vehicle equipped with a vehicle information system, according to an embodiment of the present invention, and showing interactions with a plurality of extra-vehicular data sources;

FIG. 2 is a more detailed schematic view of the vehicle and vehicle information system of FIG. 1;

FIG. 3 is schematic view of an exemplary display device of the vehicle information system of FIG. 2; and

FIG. 3A is a schematic view of an alternate embodiment of the display device of FIG. 3.

### DETAILED DESCRIPTION OF PREFERRED EMBODIMENTS

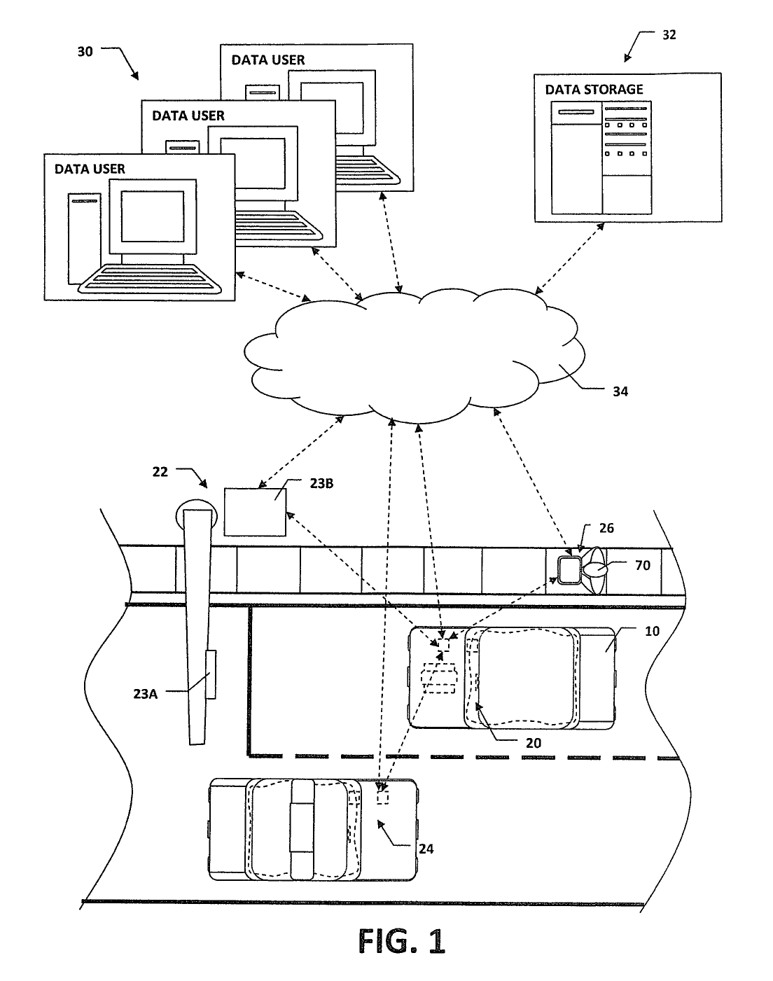

Referring to FIG. 1, a vehicle 10 is equipped with an electronic vehicle information system 20, such as an electronic license plate system, according to an embodiment of the present invention. The electronic license plate system 20 sends and receives data from a plurality of extra-vehicular data sources 22-32, including local data interface units 22-26, as well as remote data users 30 and data storage 32 exchanging data via one or more local units 22-26 through an electronic communications medium 34, such as the Internet or other public and/or private network.

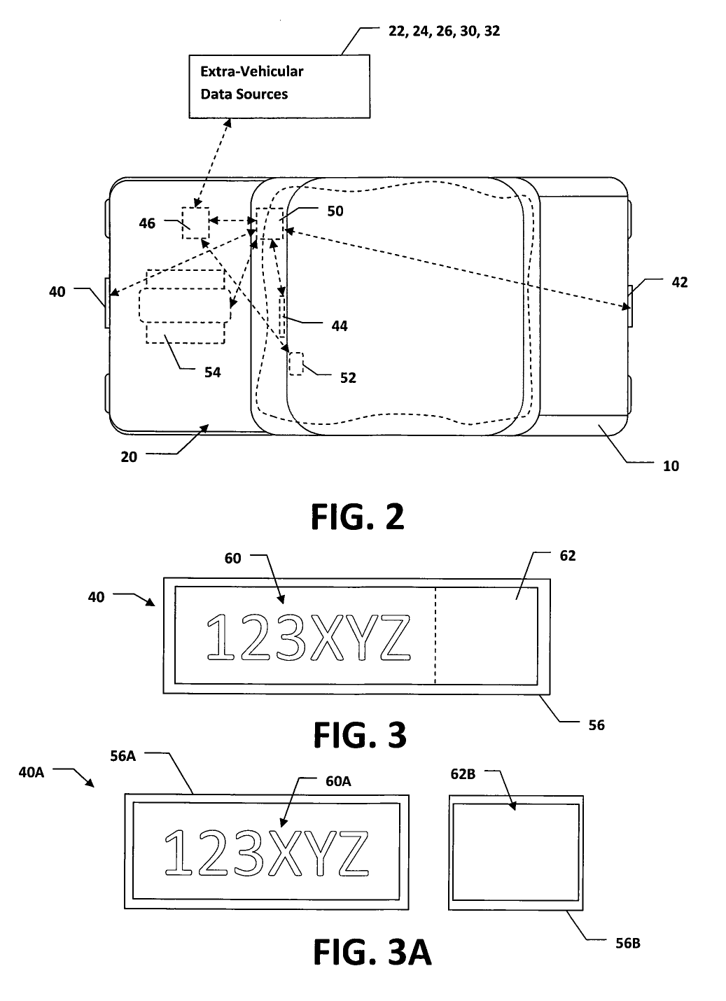

Referring to FIG. 2, the vehicle information system 20 includes a plurality of display devices 40-44, a communications device 46 and an electronic controller 50. The communications device 46 sends and receives data from the extra-vehicular data sources 22-32 and is in signal communication with the electronic controller 50 to operate the display devices 40-44.

As used herein, the term “vehicle” generally refers to any mobile structure used to transport people and/or materials from one location to another. For example, motorized and non-motorized vehicles, including motorcycles, cars, sport-utility vehicles (SUVs), vans, trucks, buses, trailers, planes, trains, boats, etc., could all beneficially employ one or more aspects of the present invention. Furthermore, vehicles can be manned or unmanned.

An example of a platform for local units 22-26 includes a traffic light system 22, or other fixed location units. The present inventor is also the inventor of U.S. Non-Provisional application Ser. No. 13/311,093, filed on Dec. 5, 2011, relating to advanced traffic signals and traffic signal systems—the contents of which application are herein incorporated by reference in their entirety. The display devices 40-44 can advantageously be operated to display all of the traffic signal information disclosed therein, and in the same configurations. For example, one or more display devices 40-44 can include a section displaying a visual representation of the condition/color of the imminent traffic signal, and another section displaying a countdown of time (preferably in seconds and/or minutes and seconds) until the next change in condition/color.

The traffic light system 22 includes a traffic signal 23A and an electronic controller/communications device 23B. Other fixed local data sources can employ data collection devices 23B that are unconnected with traffic signals 23A; for example, in neighborhoods without traffic signals, along limited access highways without traffic signals, remote and/or undeveloped locations, etc.

In addition to fixed location data devices associated traffic signal systems and non-traffic signal systems, another example is a vehicle-based system 24; carried, for example, by a police or other government agency vehicle, or other vehicle-based units. A further example is a portable unit 26, which can be carried by an individual user 70 from place to place; for example, in the form of a tablet computer carried by law enforcement or code enforcement personnel.

The display devices 40-44 are preferably low-profile flat screen-type displays—for instance, liquid crystal displays (LCDs) and/or light emitting diode displays (LEDs). Any exterior displays 40, 42 should be suitably weather-resistant or housed in suitable enclosures. The present invention is not necessarily limited to any particular type, configuration, size, shape and number of displays. For example, embodiments of the system 20 could incorporate only one or more interior displays and/or only one or more exterior displays. In one advantageous embodiment, the system could include only an interior display and a rear exterior display. Besides the front and rear of the vehicle, exterior displays could be placed at other vantage points on the vehicle's exterior, as desired, and multiple displays could be located on a single side—e.g., two separate display panels on the vehicle rear side. Additionally, display devices need not provide an exclusively visual display, but could also incorporate audible and/or other sensible signals, as well. In some embodiments, display devices can include one or more discrete indicator lights.

The present invention is also the inventor of U.S. Non-Provisional application Ser. No. 13/630,177, filed on Sep. 28, 2012, relating to vehicle data communication and display systems, the contents of which are also herein incorporated by reference in their entirety. The electronic controller 50 can further operate the display devices 40-44 to display information as described therein.

The communications device 46 can, in the broadest sense, include at least one electronic device adapted to obtain data from an extra-vehicular source 22-32. However, the communications device 46 can advantageously also receive intra-vehicular data from the vehicle and also transmit data to an extra-vehicular information repository—which could be the same as, or distinct from one or more of the sources 22-32. In an advantageous embodiment, the communications device 46 includes a transceiver that is adapted to wirelessly receive and transmit data. Additionally, the communications device 46 could include a data port—for instance, a universal serial bus (USB) port or other disk drive or data connection through which data can be uploaded to the electronic controller 50. The communications device 46 could incorporate one or more physically separated communications device—for example, one device for internal communications and a second device for external communications.

Furthermore, the communications device 46 can receive internal communications signals wirelessly; for instance from a data entry/authorization device 52 or like device, such as a key card reader, data port(s), etc. This allows vehicles 10 to be associated with owner/driver data key cards, as well as authorized non-owner/driver cards. The data entry/authorization device 52 can permit physical data connections, in addition to wireless communication. Ports for the device 52 can be located interiorly and/or exteriorly. Protective port covers can be applied where necessary or desired.

The electronic controller 50 includes at least one processor capable of executing program instructions stored in machine readable memory. The present invention is not necessarily limited to any particular number, type or configuration of processors or to any particular format or amount of machine readable memory, programming language or the like. For example, various functions of the electronic controller 50 could be accomplished by multiple processors connected via one or more data networks. Moreover, the electronic controller 50 is not necessarily a physically separate component of the system, but could be integrated into one or more other components—for example, the electronic controller 50 could be integrated into a display device or communications device. Regardless of the particular embodiment, however, all recitations of computer processors or memory include the use of hardware components, and should not be understood as a reference to processing or memory, in the abstract.

In addition to controlling the display devices 40-44, the electronic controller 50 can communicate with and/or control other vehicle components, such as an engine 54. The electronic controller 50 can thereby function to limit or prevent vehicle 10 operation. Advantageously, the electronic controller 50 can interface with automatic door locking systems, allowing locking and unlocking of doors via remote command, or per preprogrammed instructions.

In situations where a plurality of vehicles are connected, or otherwise under the control of a particular vehicle (herein “controlling vehicle”), the electronic controller 50 can also be configured to obtain and communicate vehicle data from the vehicle(s) under control (herein “slave vehicle(s)”). Examples of such situations include a tractor with one or more trailers, a train engine with one or more train cars, and a tugboat with one or more barges.

Each extra-vehicular data source 22-32 also employs at least one processor, machine-readable memory, and a communications device allowing communications directly with communications device 46 of the vehicle and/or indirectly via the data communications medium 34, such as the Internet or other network. The term data “source” does not necessarily imply the transmission of data to the system 20, but could encompass a user device that was essentially only received data.

Similarly, a local data unit 22-26 refers generically to devices that can communicate directly with a vehicle system 20. However, a local data unit 22-26 could be, in some circumstances a remote data user 30 and vice versa. Additionally, any of the sources 22-32 could be used for data storage and the designated remote data storage 32 could represent multiple data storage locations storing the same or different data.

According to aspects of the present invention, the system 20 and extra-vehicular data sources 22-32 cooperate to allow a wide range of functions, benefitting both vehicle operators, government agencies, and the public at large.

### Electronic License Plates

Referring to FIG. 3, the exterior display devices 40, 42 (only a display device 40 is shown in FIG. 3, although the features described in connection therewith are equally applicable to the display device 42) advantageously function as electronic license plates, displaying a unique vehicle identifier, such as an alphanumeric license plate number (a portion of the identifier can signify the domicile of the vehicle (e.g., home state or country, or other political subdivision). The electronic display of the license plate number offers several advantages relative to conventional license plates.

For example, the display device 40 includes a panel 56 which displays the unique identifier in a first display area 60 leaving a second display area 62 available for the display of other information, such as in a graphical/pictorial format. Alternately, referring to FIG. 3A, the display device 40A could include two or more separate display panels 56A, 56B could be used, containing the first and second display areas 60A, 62B, respectively. It will be appreciated that several additional panels and/or display areas can be used.

Via the use of the electronic license plates, information beyond simply a unique identifier can be more easily displayed to the authorities, other drivers and the general public by altering one or more properties of the display. For instance, information can be conveyed varying the color or pattern of the numbers or background, by flashing, by displaying special text, etc.

In this manner, the display devices can be operated so as to alert viewers to characteristics of a vehicle status that would be difficult or impossible with a conventional license plate. For example, the display devices can be altered to communicate that a vehicle is speeding, a vehicle is overweight, a vehicle has an expired registration, a vehicle has no insurance, a vehicle has been committing traffic infractions (e.g., running a red light, as detected by a traffic light system), a vehicle has maintenance problems with a component, a vehicle driver is underage, unlicensed and/or unauthorized (with driver status communications, for instance, by identification card data via card reader 52), and/or that a vehicle is involved in (or suspected of involvement in) a crime. Different display features could indicate special vehicle statuses, such as rental vehicles, government vehicles and the like (such statuses could also be stored and communicated electronically without external display).

In addition to communicating such data via the display devices (and some or all of this data can also be communicated to the driver and/or passengers of the vehicle via the interior display device 44) visually via the display devices, the communications device 46 can communicate the same information, directly or indirectly, to the extra-vehicular data sources 22-32. Thus, the valuable information collecting and communicating features of the present invention could be employed even in connection with vehicles lacking exterior display devices 40, 42 and/or electronic license plates. For certain types of information being accessed, notification could be provided to an affected vehicle owner/operator, and/or also in the vehicle.

To aid in displaying information—for example, when a vehicle is not running or otherwise turned off—the electronic controller 50 can be configured to energize and operate the display devices in response to external signals. For example, a user of the portable unit 26 could send a signal to the communications device 46 directing the electronic controller 50 to temporarily energize the exterior display panels 40, 42 for reading by the user. This command could be manually directed by the user via the portable unit 26, or occur automatically—e.g., a result of proximity of the portable unit 26 to a vehicle 10.

The adaptable nature of electronic license plates also facilitates the vehicle sale and registration process. As an example, a car dealership does not need to maintain temporary tags for vehicles on the lot which must then be switched for permanent tags after a vehicle sale is complete. The car dealership can simply display an authorized temporary number and upload a permanent license plate number after purchase. The same convenience is afforded to government motor vehicle departments; for instance, when private sellers bring a car in for a new registration. A switch of plates need not take place, and authorized agency personnel can simply direct the system 20 to switch the vehicle 10 registration and plate numbers. Registration renewals are likewise simplified, and can be quickly done via data signals from local or remote sources, without the need for messy (and theft prone) stickers and/or replacement plates.

Preferably, a special access card, dongle or other authorization mechanism is required to execute a registration change for a vehicle, such that vehicle users and other unauthorized parties cannot simply change the license plate, at will. Additionally, the registration information (including license plate number and other unique vehicle information—e.g., vehicle identification number (VIN)) is stored in an extra-vehicular data storage 32, so that attempted tampering with a vehicle's system 20 can be detected.

Where key cards are employed, the key cards can be switched from dealer key cards to owner key cards in connection with the sale process. Once an owner card is associated with the vehicle, the owner can have the capability to authorize key cards for supplemental vehicle users—such as other family members or friends, or in the case of a business owner, employees. Preferably, owner key cards would allow greater access to vehicle data, as opposed to non-owner cards which would typically only permit vehicle operation. The owner could furthermore customize privileges of different card holders. Additionally, current address information for owners and/or authorized drivers could be updated via the system 20 or other data entry mechanism.

### Electronic Component Tracking

The vehicle registration/license plate process is only one administrative feature that can be simplified and made more fraud resistant by use of aspects of the vehicle information system 20 and associated extra-vehicular data sources 22-32. Many vehicle components, such as the engine, the frame, the wheels and the windows can have unique identifiers associated therewith (e.g. an alphanumeric serial number). Depending on particular local, state or Federal regulatory schemes, the unauthorized alteration of such numbers and/or re-association with different vehicles can be forbidden as a method of deterring theft and fraud.

With the system 20, the electronic controller 50 can store all tracked component numbers for the vehicle 10, and when an entity (such as a repair shop, car dealer, or government agency) needs to verify the numbers, the information can simply be downloaded from the system 20. As with vehicle registration information, special authorization can be required to alter component numbers stored in the electronic controller 50, and a separate record can be stored in an extra-vehicular data storage location 32 for a back-up comparison with the numbers stored in the electronic controller.

When an authorized party changes a tracked component (for example a body shop), the new component number is updated with the system 20 and the data storage location 32. A mismatch between an actual component number on the vehicle 10 and the stored numbers (either locally or remotely) is sign that something is amiss. Likewise, a body shop or other facility will quickly discover if they are holding stolen merchandise when a replacement number for a component to be installed in a vehicle turns out to correspond to another vehicle. Prior to reselling used cars, used car dealers can also upload this information, with discrepancies being flagged and reported. Scrap yards would typically be the last stage in the process, uploading vehicle and component information for vehicles and/or components legally junked.

The component information can be input into the electronic controller 50 via the communications device 46 by the manufacturer and by subsequent authorized repair/replacement entities. Also, “smart” components could be used, which store their own identifiers in electronic form, with this information communicated to the electronic controller 50 directly. Thus, the electronic controller 50 would “know” immediately when a component was removed and/or replaced. Automatic notifications of discrepancies in component numbers can be sent to appropriate law enforcement agencies for follow-up, either from the electronic controller 50, a system 30 employed by another data user, or a centralized data storage repository 52.

### Vehicle Location Monitoring

Since the system 20 has robust communications capability, a vehicle 10 equipped with a global positioning system (GPS) or other navigation-type system could readily communicate (either automatically or in response to queries) its location to the various data users 30 (including local, state and Federal security, code and/or law enforcement agencies, either in the U.S. or elsewhere) and (for archival or record purposes) to a storage location 32. Via interaction with traffic signal systems 22, the location of even vehicles 10 not so equipped can be regularly monitored.

Traffic signals of a system 22 are generally fixed in known locations. When a vehicle 10 approaches a traffic signal of a system 22, the position of the vehicle 10 is known. Also discernible are further data points like the speed of the vehicle 10 approaching and departing a traffic signal, vehicle direction, vehicle compliance with the signal and the like. Thus, a reliable record of where a vehicle 10 has been, and well as useful predictors of where a vehicle 10 is headed can be gained without “tracking” the vehicle in a more conventional sense. In addition to traffic light systems, vehicle 10 detections by local units 24, 26 (where location of units 24, 26 is known) can give further location data points for the vehicle, even in areas where interactions with traffic signal systems might not occur.

With proper authorization, a government data user 30 can access records (for instance in data storage 32) and see a record of what vehicles 10 where in a given vicinity at a given time. Such data could help identify suspects for a crime, for example. In addition to yielding useful historical data, the system could be used in real time, or close to real time. For instance, for a recently committed crime, the present locations of all vehicles that could have been on scene can be displayed to a data user 30. Special indications can be given with respect to vehicles that meet predetermined criteria for suspicious behavior—such as speeding away from a crime scene, disobeying traffic signals, and the like. Exterior displays of vehicles of interest can be altered to make them more apparent to law enforcement personnel.

As noted previously, the vehicle information system 20, and more particularly the electronic controller 50, is not limited to operating the display devices 40-44 and communication information. Additionally, the electronic controller 50 can interact with vehicle components, such as the engine 54. Using this capability, properly authorized personnel could remotely limit the speed of, or disable, a vehicle 10 of interest. This command could be manually initiated by authorized personnel—or in certain cases (for example, where an unauthorized driver attempts to operate a vehicle) could occur automatically. Also, instructions to stop or to proceed to a specified location could also be transmitted to the operator of such a vehicle via the internal display device 44.

These are just some examples of the how vehicle information systems, electronic license plates and related systems and methods of the present invention can be put to advantageous use. In general, the foregoing embodiments and examples are provide for illustrative and enablement purposes; those skilled in the art will appreciate that the present invention is not necessarily limited thereto. For example, additional modifications, combinations and sub-combinations of illustrated elements, as well as adaptations to particular circumstances, will fall within the scope of the invention herein shown and described and of the claims appended hereto.

What is claimed is:

1. A vehicle information collection and dissemination system comprising:
at least one communications device for sending and receiving vehicular data to and from communications devices in vehicles and other extra-vehicular data sources; and
at least one processor with machine-readable memory configured to communicate with the communications devices in vehicles and other extra-vehicular data sources.

2. The system of claim 1, wherein the at least one processor and memory are configured to send instructions to the at least one vehicle to energize a display device thereof to display vehicle information.

3. The system of claim 1, wherein the at least one processor and memory are configured to communicate at least one vehicle location to another extra-vehicular data source, the communicated at least one vehicle location being based upon a vehicle with which the at least communications device communicated and a known location of the system.

4. The system of claim 3, wherein the at least one processor and memory are configured to receive at least one vehicle location from another extra-vehicular data source.

5. The system of claim 1, wherein the at least one processor and memory are configured to send instructions to the at least one vehicle effective to effect at least one of:
vehicle speed limitation; and
vehicle disablement.

6. The system of claim 1, wherein the at least one processor and memory are configured to communicate with the communications devices in vehicles and other extra-vehicular data sources in order to determine component identifiers for the at least one vehicle.

7. The system of claim 6, wherein the at least one processor and memory are configured to automatically generate an alert notification if there is a discrepancy in the determined component identifiers.

8. The system of claim 1, wherein the at least one processor and memory are configured to communicate authorization to vehicles to change vehicle information associated therewith.

9. The system of claim 8, wherein the vehicle information includes at least one of:
a component identifier;
a registration number;
a registration status; and
an insurance status.

10. The system of claim 1, wherein the at least one processor and memory are configured to communicate with the communications devices in vehicles in order to alter an exterior vehicle display to indicate a change in vehicle status information.

11. The system of claim 1, wherein the vehicle status information includes at least one of:
vehicle speed;
vehicle weight;
vehicle registration status;
vehicle insurance status;
vehicle traffic signal compliance;
vehicle maintenance status;
vehicle owner/driver information; and
vehicle crime involvement.

12. The system of claim 1, further comprising at least one traffic signal also controlled by the system.

13. The system of claim 1, wherein the system is vehicle mounted.

14. The system of claim 1, wherein the system is hand-held.

15. The system of claim 1, wherein the system is in a fixed location.

16. A computer-based method of vehicle theft and fraud prevention, the method comprising:
determining a plurality of component identifiers for vehicle components for a vehicle from a list of component identifiers stored electronically in the vehicle; and
comparing the stored component identifiers with the actual component identifiers.

17. The method of claim 16, further comprising comparing the stored component identifiers from the at least one vehicle with a list of component identifiers stored in an extra-vehicular data source.

18. The method of claim 16, further comprising updating a component identifier for a replacement component.

19. The method of claim 18, wherein updating a component identifier for a replacement component includes submitting authorization to update the component identifier.

20. The method of claim 16, further comprising an initial step of entering all component identifiers for a newly-manufactured vehicle.

21. The method of claim 16, further comprising a step of entering component identifiers for a scrapped vehicle or components thereof.

22. The method of claim 16, further comprising a step of automatically generating an alert notification if an unauthorized discrepancy in vehicle component identifiers is identified.
